(19) United States
(12) Patent Application Publication
(10) Pub. No.: US 2025/0077943 A1
(43) Pub. Date: Mar. 6, 2025

(54) OFFLINE REINFORCEMENT LEARNING BASED FORESIGHTED DECISION-MAKING METHOD AND APPARATUS FOR MULTI-AGENT INTERACTION

(71) Applicant: FOUNDATION OF SOONGSIL UNIVERSITY-INDUSTRY COOPERATION, Seoul (KR)

(72) Inventors: Min Hae KWON, Seoul (KR); Dong Su LEE, Seoul (KR)

(73) Assignee: FOUNDATION OF SOONGSIL UNIVERSITY-INDUSTRY COOPERATION, Seoul (KR)

(21) Appl. No.: 18/414,026

(22) Filed: Jan. 16, 2024

(30) Foreign Application Priority Data
Aug. 28, 2023 (KR) 10-2023-0113002

(51) Int. Cl. G06N 20/00; G07C 5/08

(52) U.S. Cl. CPC G06N 20/00; G07C 5/0816

(57) ABSTRACT

An offline reinforcement learning-based foresighted decision-making apparatus and method for interaction between multiple agents. The offline reinforcement learning-based foresighted decision-making apparatus comprises a processor; and a memory connected to the processor, wherein the memory comprises program instructions for performing steps comprising collecting a raw data set about environment surrounding the multiple agents, processing the raw data set into a first data set containing at least one of state information, observation information, and action information in reinforcement learning, generating an episodic future data set from the first data set based on some of the state information, observation information, and action information, generating an episodic future data prediction model using the episodic future data set, and learning an optimal policy for decision-making for each of the multiple agents through offline reinforcement learning using the generated episodic future data prediction model or the episodic future data set.

### CROSS-REFERENCE TO RELATED APPLICATIONS

This application claims the benefit of Korean Application No. 10-2023-0113002, filed Aug. 28, 2023, in the Korean Intellectual Property Office. All disclosures of the document named above are incorporated herein by reference.

### TECHNICAL FIELD

The present invention relates to an offline reinforcement learning-based foresighted decision-making method and apparatus for multi-agent interaction.

### BACKGROUND ART

For tasks that require decision-making based on interaction with the environment, deep reinforcement learning using deep neural networks is being considered as a promising method. In reinforcement learning, an agent learns a policy so that it can perform actions that can obtain optimal rewards in a specific environment.

In the case of existing online reinforcement learning, policies are learned through real-time interaction with the environment. If this requires physical devices (vehicles, drones, robots, etc.), online reinforcement learning can result in significant losses from an economic and social perspective. Additionally, most reinforcement learning considers model-free methods and determines actions based on environmental (or observation) information at a single time point. This may not be a problem if there are no interacting agents nearby. However, in the case of a multi-agent situation, if future actions that occur through the actions of other agents are not considered, safety problems may arise and efficiency may be reduced.

For example, in the case of an autonomous vehicle, if it selects an action considering only the current state without considering the actions of other vehicles, it may cause a collision with another vehicle.

### DISCLOSURE

### Technical Issues

In order to solve the problems of the prior art described above, the present invention proposes an offline reinforcement learning-based foresighted decision-making method and apparatus for interaction between multiple agents that can consider an offline reinforcement learning method so that a specific agent can be learned in an offline environment rather than an online environment, and determine actions by considering current and future situations.

### Technical Solution

In order to achieve the above object, according to an embodiment of the present invention, an offline reinforcement learning based foresighted decision-making apparatus for interaction between multiple agents comprises a processor; and a memory connected to the processor, wherein the memory comprises program instructions for performing steps comprising collecting a raw data set about environment surrounding the multiple agents, processing the raw data set into a first data set containing at least one of state information, observation information, and action information in reinforcement learning, generating an episodic future data set from the first data set based on some of the state information, observation information, and action information, generating an episodic future data prediction model using the episodic future data set, and learning an optimal policy for decision-making for each of the multiple agents through offline reinforcement learning using the generated episodic future data prediction model or the episodic future data set.

The memory may further comprise program instructions for performing steps comprising inputting data included in the first data set as sample data into the episodic future data prediction model, and training the episodic future data prediction model by comparing the similarity between first episodic future data inferred from the episodic future data prediction model and second episodic future data previously generated for the sample data.

The episodic future data set may be generated for each agent.

The episodic future data set may be defined as the next state information or next observation information predicted for each agent while its own action is not determined.

The memory may further comprise program instructions for performing steps comprising sampling data included in the first data set as sample data, generating episodic future data for the sample data using the generated episodic future data prediction model or the episodic future data set, calculating an objective function for a decision-making network using the episodic future data, and updating a parameter of a decision-making network using the calculated objective function.

The memory may further comprise program instructions for performing steps comprising collecting, after learning of the optimal policy is completed, state information or observation information from the environment by each agent, predicting episodic future data using the collected state information or observation information, using the predicted episodic future data to decide on action at next time point.

The multiple agents may be defined as agents for operating an autonomous vehicle.

The state information may include vectors of speeds, positions, and lane numbers of vehicles around each of the multiple agents.

The observation information may include a relative speed vector between observable vehicles of each of the multiple agents, a relative distance vector, a traffic density vector for each visible lane, and a presence vector of a visible lane.

According to another aspect of the present invention, an offline reinforcement learning-based foresighted decision-making apparatus comprises a processor; and a memory connected to the processor, wherein the memory comprises program instructions for performing steps comprising collecting, by an agent, state information or observation information from surrounding environment, generating, by the agent, prediction data by inputting the collected state information or observation information into a pre-built episodic future data prediction model, and applying, by the agent, the episodic future data prediction model to offline reinforcement learning and inputting the prediction data into a decision-making model with a learned optimal policy to determine action at a current time point.

According to another aspect of the present invention, a method for performing offline reinforcement learning-based foresighted decision-making for interaction between multiple agents in an apparatus including a processor and memory comprises collecting a raw data set about environment surrounding the multiple agents; processing the raw data set into a first data set containing at least one of state information, observation information, and action information in reinforcement learning; generating an episodic future data set from the first data set based on some of the state information, observation information, and action information; generating an episodic future data prediction model using the episodic future data set; and learning an optimal policy for decision-making for each of the multiple agents through offline reinforcement learning using the generated episodic future data prediction model or the episodic future data set.

### Advantageous Effects

According to the present invention, by combining an episodic future thinking (EFT) mechanism with offline reinforcement learning, each of multiple agents can consider the upcoming future, which has the advantage of establishing an optimal policy.

### BRIEF DESCRIPTION OF DRAWINGS

These and/or other aspects will become apparent and more readily appreciated from the following description of the embodiments, taken in conjunction with the accompanying drawings in which:

FIG. 1 is a diagram illustrating the configuration of an offline reinforcement learning based foresighted decision-making apparatus for interaction between multiple agents according to this embodiment;

FIG. 2 is a flow chart briefly illustrating the foresighted decision-making process according to this embodiment;

FIG. 3 is a diagram showing the general structure of reinforcement learning;

FIG. 4 is a diagram illustrating a data preprocessing process according to this embodiment;

FIG. 5 is a diagram illustrating a current state and an episodic future state according to this embodiment;

FIG. 6 is a diagram illustrating the generation process of an episodic future data prediction model according to this embodiment;

FIG. 7 is a diagram showing the optimal policy learning process according to this embodiment;

FIG. 8 is a diagram illustrating the decision-making process according to this embodiment;

FIG. 9 is a diagram showing details of a sequential view of the state transition process; and

FIG. 10 is a diagram illustrating a decision-making process according to this embodiment.

### DETAILED DESCRIPTION OF EMBODIMENTS

Since the present invention can make various changes and have various embodiments, specific embodiments will be illustrated in the drawings and described in detail in the detailed description. However, this is not intended to limit the present invention to specific embodiments, and should be understood to include all changes, equivalents, and substitutes included in the spirit and technical scope of the present invention.

The terms used herein are only used to describe specific embodiments and are not intended to limit the invention. Singular expressions include plural expressions unless the context clearly dictates otherwise. In this specification, terms such as “comprise” or “have” are intended to indicate the presence of features, numbers, steps, operations, components, parts, or combinations thereof described in the specification, but are not intended to exclude in advance the possibility of the existence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope of maintaining the technical spirit of the present invention, and a plurality of embodiments may be re-implemented as a single integrated embodiment even if separate descriptions are omitted.

In addition, when describing with reference to the accompanying drawings, identical or related reference numerals will be assigned to identical components regardless of the reference numerals, and overlapping descriptions thereof will be omitted. In describing the present invention, if it is determined that a detailed description of related known technologies may unnecessarily obscure the gist of the present invention, the detailed description will be omitted.

This embodiment proposes a method for building a model to predict episodic future data for the near future in a mission-critical system such as autonomous driving, and using an offline reinforcement learning method based on the episodic future data prediction model and a data set processed from the raw data to determine the optimal policy for multiple agents.

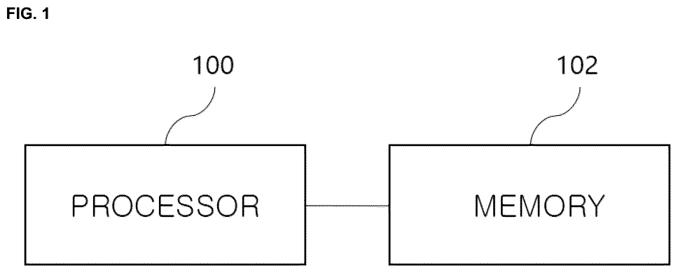

FIG. 1 is a diagram illustrating the configuration of an offline reinforcement learning based foresighted decision-making apparatus for interaction between multiple agents according to this embodiment.

As shown in FIG. 1, the foresighted decision-making apparatus according to this embodiment may include a processor 100 and a memory 102.

The apparatus according to this embodiment may be a server that learns the optimal policy for autonomous vehicles and applies it, but is not necessarily limited to this.

Here, the processor 100 may include a central processing unit (CPU) capable of executing a computer program or another virtual machine.

The memory 102 may include a non-volatile storage device, such as a non-removable hard drive or a removable storage device. The removable storage devices may include compact flash units, USB memory sticks, etc. The memory 102 may also include volatile memory such as various random access memories, and may be defined as a computer-readable recording medium.

The memory 102 according to this embodiment stores program instructions for generating an episodic future data set, generating an episodic future data prediction model, and learning an optimal policy based on offline reinforcement learning.

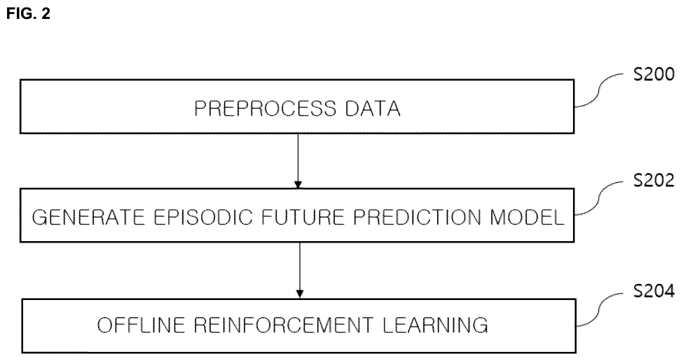

FIG. 2 is a flow chart briefly illustrating the foresighted decision-making process according to this embodiment.

The server according to this embodiment sequentially performs data preprocessing of the raw data set stored in the database for offline reinforcement learning (step 200), generation of an episodic future data prediction model (step 202), and offline reinforcement learning (step 204).

The optimal policy learned through offline reinforcement learning is transferred to one or more agents, and one or more agents perform single-step future (episodic future) predictions and decide their own actions.

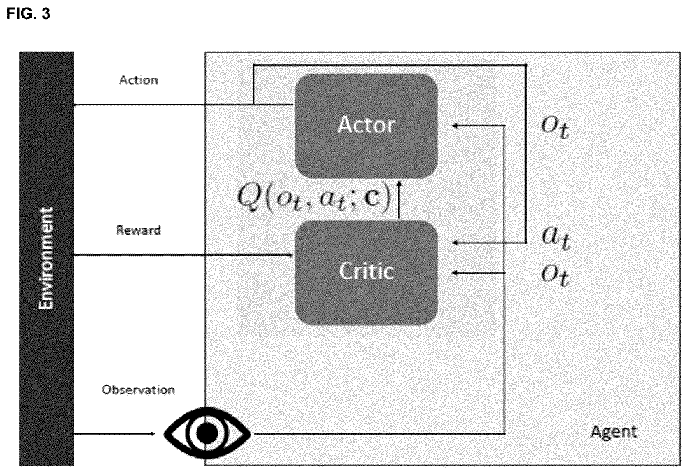

FIG. 3 is a diagram showing the general structure of reinforcement learning.

Referring to FIG. 3, reinforcement learning learns the optimal policy based on data samples consisting of pairs (observation, action, next observation, reward).

Here, observation refers to information that each agent can observe, and can be defined as a subset of state, which is all information that can be collected from the environment.

In reinforcement learning, the optimal policy x is learned to determine the optimal action of an agent to maximize temporal accumulated reward.

In this embodiment, for convenience of explanation, the future of the next step, that is, episodic future state information or episodic future observation information, is defined as episodic future data, and a model that predicts episodic future state information or episodic future observation information is defined as an episodic future data prediction model.

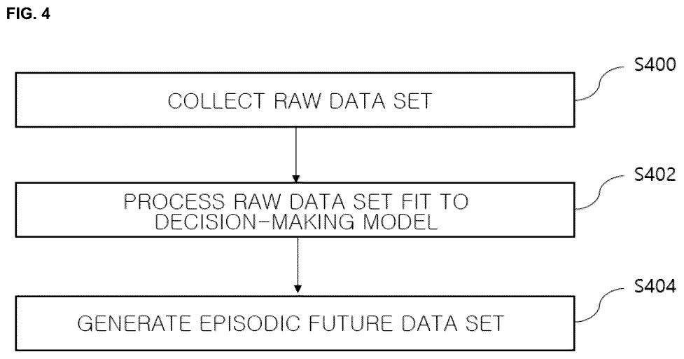

FIG. 4 is a diagram illustrating a data preprocessing process according to this embodiment.

Referring to FIG. 4, the apparatus according to this embodiment collects a raw data set regarding the environment surrounding multiple agents (step 400).

Afterward, the raw data set is processed to fit the decision-making model (step 402).

Step 402 is a process of processing the raw data set into a first data set including at least one of state information, observation information, and action information in reinforcement learning.

Here, the first data set may be a process of processing raw data into <state, action> pairs or <observation, action> pairs.

After step 402 is completed, the apparatus according to the present embodiment generates an episodic future data set from the processed data set based on some of the state information, observation information, and action information (step 404).

Step 404 may be a process of generating predicted episodic future data for the near future based on <state, action> information or <observation, action> information.

Here, state information and observation information may include action information of other agents.

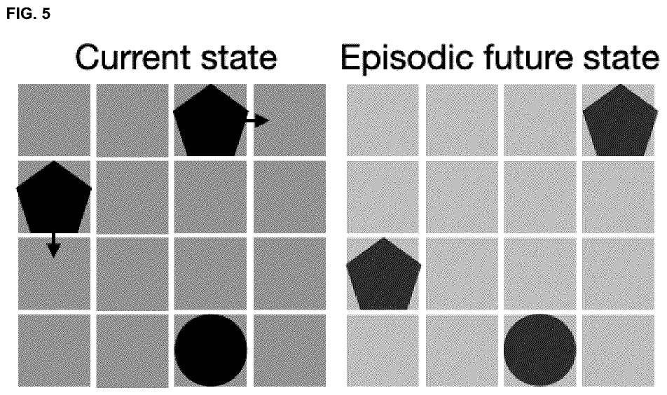

FIG. 5 is a diagram illustrating a current state and an episodic future state according to this embodiment.

As shown in FIG. 5, episodic future data is defined as the state or observation information in the next step while the agent's own action has not been determined, and is generally distinguished from the next state after the agent's action is determined in reinforcement learning.

As described above, decision-making according to this embodiment may be a process for controlling an autonomous vehicle, where the state information may be a vector of the speed, position, and lane number of surrounding vehicles for each of the multiple agents, and the observation information may include a relative speed vector between each observable vehicle of multiple agents, a relative distance vector, a traffic density vector for each visible lane, and a presence vector of visible lanes.

The apparatus according to this embodiment generates an episodic future data prediction model using an episodic future data set.

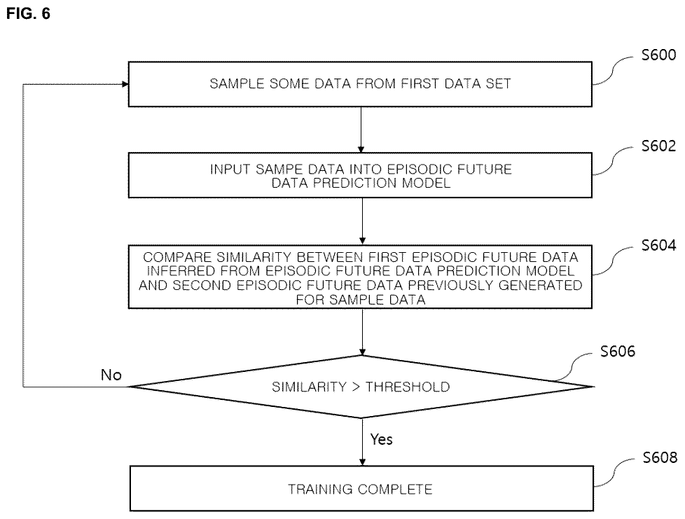

FIG. 6 is a diagram illustrating the generation process of an episodic future data prediction model according to this embodiment.

Referring to FIG. 6, some data is sampled from the first data set in step 402 of FIG. 4 (step 600).

Next, the sample data sampled in step 600 is input into the episodic future data prediction model (step 602).

Here, the sample data may be currently available information such as current state information, observation information, or action information, and the inferred value may be defined as episodic future state information or episodic future observation information.

The similarity between the first episodic future data inferred from the episodic future data prediction model and the second episodic future data previously generated with respect to the sample data is compared (step 604).

The similarity calculated in step 604 is compared with a preset threshold (step 606), and training of the episodic future data prediction model is terminated until the similarity becomes higher than the threshold (step 608).

According to this embodiment, the optimal policy for decision-making for each of multiple agents is learned through offline reinforcement learning using a trained episodic future data prediction model and a pre-generated episodic future data set.

Offline reinforcement learning can reuse past data without real-time interaction with the environment.

Through these properties, the information in the data set can be utilized and predictions can be performed in model-free reinforcement learning, which has been difficult to attempt so far.

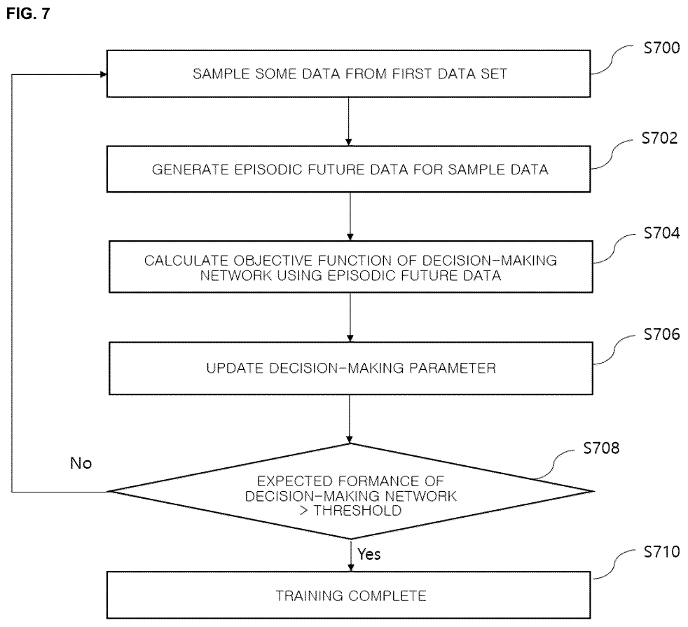

FIG. 7 is a diagram showing the optimal policy learning process according to this embodiment.

Referring to FIG. 7, the apparatus according to this embodiment samples data included in the first data set as sample data (step 700).

The above-described sample data is input into an episodic future data prediction model, or episodic future data for the sample data is generated using a previously generated episodic future data set as shown in FIG. 4 (step 702).

Next, the objective function for the decision-making network is calculated using the episodic future data (step 704), and the decision-making network parameters are updated based on the calculated objective function (step 706).

The expected performance of the decision-making network according to the parameter update in step 706 is compared with a preset threshold (step 708), and if the expected performance exceeds the threshold, training is completed (step 710).

Data preprocessing, episodic future data prediction model generation, and optimal policy learning according to this embodiment can be performed on an external server of an apparatus containing multiple agents, and the learned optimal policy is transmitted to each apparatus, and the agent within the apparatus can be used to determine the action.

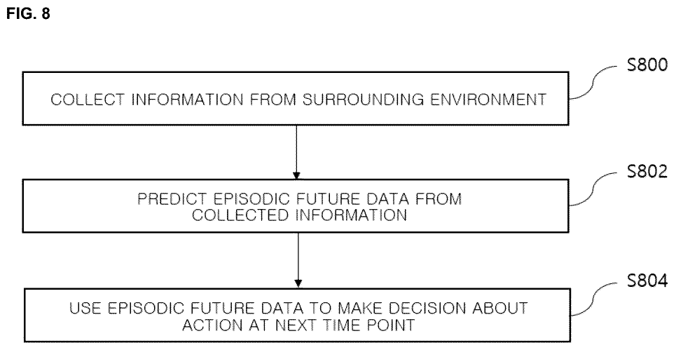

FIG. 8 is a diagram illustrating the decision-making process according to this embodiment.

Referring to FIG. 8, each agent collects information from its surrounding environment (step 800).

Information collected in step 800 may include state information about the environment or observation information within an observable range.

Here, state information or observation information may also include action information of other agents.

Each agent predicts episodic future data by inputting the collected state information or observation information into the episodic future data prediction model (step 802).

In step 802, the episodic future data may be episodic future state information if the collected information is state information, or may be episodic future observation information if the collected information is observation information.

Afterward, decision-making regarding action at the current time point is made using the predicted episodic future data (step 804).

When the current time point is t, episodic future data is predicted data at time t+1, and each agent makes decisions about the action to be taken at time t through the episodic future data.

According to this embodiment, steps 800 to 804 are performed iteratively.

Combining the episodic future thinking (EFT) mechanism according to this embodiment with offline reinforcement learning can be a powerful approach to building optimal policies because it allows agents to consider the upcoming future.

The decision-making network according to this embodiment can be defined as ETF-POMDP in that it combines an episodic future thinking mechanism and a partially observable Markov decision process (POMDP).

In ETF-POMDP, the process of determining an action can be formalized as a tuple of M= [symbol] [symbol] , [symbol] , [symbol] , [symbol] , Ω, R, γ [symbol] .

The tuple M contains state s∈ [symbol] , observation 0∈ [symbol] , action a∈ [symbol] , reward function R(o, a, o′), state transition model [symbol] (s′|s, a), and observation transition model Ω(o|s), and the time discount factor is γ∈[0, 1).

Before explaining the EFT-POMDP framework, the sequential perspective of the state transition model [symbol] for the state transition process of POMDP for multi-agent systems will be described.

The state transition probability depends on the current state and joint actions, which can be decomposed into a tuple containing the agent's actions and the actions of other agents. In this context, a sequential perspective is adopted to capture the state transition processor.

For convenience of explanation below, the explanation will focus on the fact that the episodic future data is episodic future observation information.

$$( {s}^{′} \vert s , a ) = ( \tilde{s} \vert s , {a\_}_{i} , {a}_{i} = ∅ ) \times ( {s}^{′} \vert \tilde{s} , {a\_}_{i} = ∅ ) \qquad [ Equation l ]$$

Here, \tilde{s} the ETF state, A is the joint action of all agents, Ø is an action not performed (i.e., null action), and the subscript −i refers to the case excluding the ith agent.

Specifically, the EFT state \tilde{s} represents an intermediate stage between the current s and next s′ stages.

This perspective is consistent with the episodic future thinking mechanism method, in which an agent predicts episodic future observation information without executing actions for decision-making, and performs actions based on the predicted episodic future information.

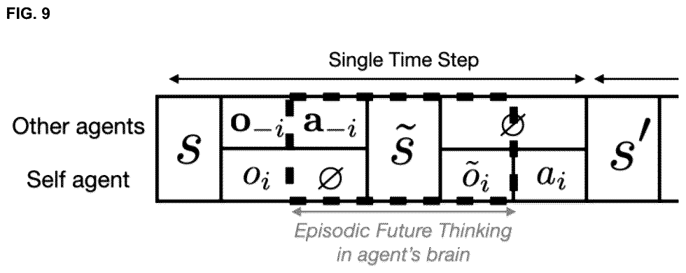

FIG. 9 is a diagram showing details of a sequential view of the state transition process.

In FIG. 9, the agent learns an optimal EFT policy πᵢ(aᵢ|õ) that determines the action aᵢ that maximizes the discounted total expected future reward, given the episodic future observation information õ.

The EFT function Q is defined as follows.

$$Q ( \tilde{o} , {a}_{i} ) = \int d {\tilde{o}}^{′} {\_}^{} ( {\tilde{o}}^{′} \vert \tilde{o} , {a}_{i} , {a\_}_{i} = ∅ ) \qquad [ Equation 2 ]$$

$$( \tilde{R} ( \tilde{o} , {a}_{i} , {\tilde{o}}^{′} ) + γ {max}_{a} Q ( {\tilde{o}}^{′} , a ) )$$

Here, [symbol] (õ′|õ, aᵢ, a₋ᵢ=Ø) is the EFT transition probability function and the EFT reward function is \tilde{R}(õ, aᵢ, õ′).

First of all, the EFT transition probability function is defined as follows.

$${\_}^{} ( {\tilde{o}}^{′} \vert \tilde{o} , {a}_{i} ) = \int \int \int \int d \tilde{s} {da}^{′} {\_}_{i} {ds}^{′} d {\tilde{s}}^{′} \overline{Ω} ( \tilde{s} \vert \tilde{o} ) \qquad [ Equation 3 ]$$

$$( {s}^{′} \vert \tilde{s} , {a}_{i} , {a\_}_{i} = ∅ ) ( {\tilde{s}}^{′} \vert {s}^{′} , {a}^{′} {\_}_{i} , {a}_{i} = ∅ ) Ω ( {\tilde{o}}^{′} \vert {\tilde{s}}^{′} )$$

Here, Ω̅(s|o) refers to the likelihood function of the posterior observation probability Ω(o|s), and Ω̅(s|o) is the probability for the environmental state s when the observation of the agent is o.

As a result, the observation-based EFT reward function is as follows:

$$\tilde{R} ( \tilde{o} , {a}_{i} , {\tilde{o}}^{′} ) = \int \int d {\tilde{o}}^{′} d \tilde{o} Ω ( {\tilde{o}}^{′} \vert {\tilde{s}}^{′} ) Ω ( \tilde{o} \vert \tilde{s} ) \overline{R} ( \tilde{s} , {a}_{i} , {\tilde{s}}^{′} ) \qquad [ Equation 4 ]$$

R̅(\tilde{s}, aᵢ, \tilde{s}′) represents the state-based EFT reward function. This reward function is based on vanilla POMDP's reward function R(−) as follows:

$$\overline{R} ( \tilde{s} , {a}_{i} , {\tilde{s}}^{′} ) = \int \int \int \int d \tilde{s} {da}^{′} {\_}_{i} d {\tilde{s}}^{′} {da}^{′} {\_}_{i} ( {\tilde{s}}^{′} \vert {s}^{′} , {a}^{′} {\_}_{i} , {{a}_{i}}^{′} = ∅ ) \qquad [ Equation 5 ]$$

$$( \tilde{s} \vert {s}_{t} , {a}^{′} {\_}_{i} , {a}_{i} = ∅ ) R ( s , {a}_{i} , {s}^{′} ) .$$

Below, offline reinforcement learning based on episodic future thinking is explained in detail.

To integrate episodic future thinking into offline reinforcement learning, a decision-making network is built and an objective function and Q function for policy update is provided.

Specifically, the actor-critic algorithm is modified to approximate policy and Q functions in high-dimensional observation and action spaces.

To obtain EFT information, the prior probability of the environmental model is required.

However, when considering model-free reinforcement learning, knowing the prior probability is intangible.

To solve this problem, an episodic future data prediction model m_{ψ}(õ|o) is built to predict EFT observation õ based on the current observation information o.

Due to the characteristics of offline reinforcement learning, EFT information can be collected in advance and used for learning.

The objective function of the episodic future data prediction model is as follows.

$$ℒ ( ψ ) = {( \tilde{o} - {m}_{ψ} ( \tilde{o} \vert o ) )}^{2} \qquad [ Equation 6 ]$$

The decision-making network according to this embodiment may be an EFT actor-critic network.

The actor-critic reinforcement learning algorithm is utilized to approximate policies and Q-functions in continuous state and action spaces. To implement the EFT function in the actor-critic algorithm, the objective function of the actor-critic network is modified as follows.

$$ℒ ( ϕ ) = - {Q}_{θ} ( \tilde{o} , {π}_{ϕ} ( {a}_{i} \vert \tilde{o} ) ) , \qquad [ Equation 7 ]$$

$$\begin{matrix}ℒ ( θ ) = transition ( \tilde{o} ∼ {m}_{ψ} ( \cdot \vert o ) , {a}_{i} , r , {\tilde{o}}^{′} ∼ {m}_{ψ} ( \cdot \vert {o}^{′} ) ) \\ = {( Q ( \tilde{o} , {a}_{i} ) - ( r + γQ ( {\tilde{o}}^{′} , {{a}_{i}}^{′} ) ) )}^{2} .\end{matrix}$$

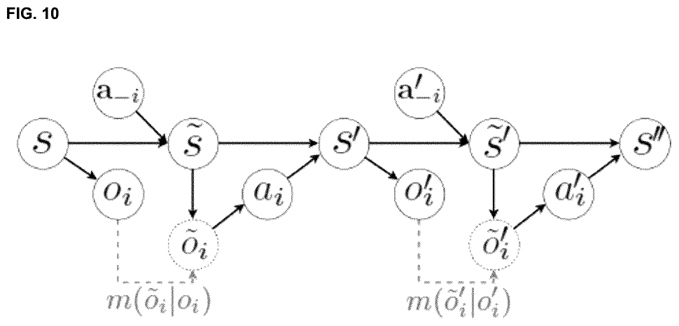

FIG. 10 is a diagram illustrating a decision-making process according to this embodiment.

Referring to FIG. 10, when the ith agent collects observation information (oᵢ), rather than determining an action through this, the action (aᵢ) is determined using episodic future data (õᵢ) predicted through an episodic future data prediction model.

The above-described embodiments of the present invention have been disclosed for illustrative purposes, and those skilled in the art will be able to make various modifications, changes, and additions within the spirit and scope of the present invention, and such modifications, changes, and additions should be regarded as falling within the scope of the patent claims below.

1. An offline reinforcement learning-based foresighted decision-making apparatus for interaction between multiple agents comprising:
a processor; and
a memory connected to the processor,
wherein the memory comprises program instructions for performing steps comprising,
collecting a raw data set about environment surrounding the multiple agents,
processing the raw data set into a first data set containing at least one of state information, observation information, and action information in reinforcement learning,
generating an episodic future data set from the first data set based on some of the state information, observation information, and action information,
generating an episodic future data prediction model using the episodic future data set, and
learning an optimal policy for decision-making for each of the multiple agents through offline reinforcement learning using the generated episodic future data prediction model or the episodic future data set.

2. The apparatus of claim 1, wherein the memory further comprises program instructions for performing steps comprising,
inputting data included in the first data set as sample data into the episodic future data prediction model, and
training the episodic future data prediction model by comparing similarity between first episodic future data inferred from the episodic future data prediction model and second episodic future data previously generated for the sample data.

3. The apparatus of claim 1, wherein the episodic future data set is generated for each agent.

4. The apparatus of claim 3, wherein the episodic future data set is defined as next state information or next observation information predicted for each agent while its own action is not determined.

5. The apparatus of claim 1, wherein the memory further comprises program instructions for performing steps comprising,
sampling data included in the first data set as sample data,
generating episodic future data for the sample data using the generated episodic future data prediction model or the episodic future data set,
calculating an objective function for a decision-making network using the episodic future data, and
updating a parameter of a decision-making network using the calculated objective function.

6. The apparatus of claim 1, wherein the memory further comprises program instructions for performing steps comprising,
collecting, after learning of the optimal policy is completed, state information or observation information from the environment by each agent,
predicting episodic future data using the collected state information or observation information,
using the predicted episodic future data to decide on an action at a next time point.

7. The apparatus of claim 1, wherein the multiple agents are defined as agents for operating an autonomous vehicle.

8. The apparatus of claim 7, wherein the state information includes vectors of speeds, positions, and lane numbers of vehicles around each of the multiple agents.

9. The apparatus of claim 7, wherein the observation information includes a relative speed vector between observable vehicles of each of the multiple agents, a relative distance vector, a traffic density vector for each visible lane, and a presence vector of a visible lane.

10. An offline reinforcement learning-based foresighted decision-making apparatus comprising
a processor; and
a memory connected to the processor,
wherein the memory comprises program instructions for performing steps comprising,
collecting, by an agent, state information or observation information from surrounding environment,
generating, by the agent, prediction data by inputting the collected state information or observation information into a pre-built episodic future data prediction model, and
applying, by the agent, the episodic future data prediction model to offline reinforcement learning and inputting the prediction data into a decision-making model with a learned optimal policy to determine action at a current time point.

11. The apparatus of claim 10, wherein the optimal policy is learned from a server connected to the apparatus through a network,
wherein the server,
collects a raw data set about environment surrounding multiple agents,
processes the raw data set into a first data set containing at least one of state information, observation information, and action information in reinforcement learning,
generates an episodic future data set from the first data set based on some of the state information, observation information, and action information,
generates an episodic future data prediction model using the episodic future data set, and
learns an optimal policy for decision-making for each of the multiple agents through offline reinforcement learning using the generated episodic future data prediction model or the episodic future data set.

12. A method for performing offline reinforcement learning based foresighted decision-making for interaction between multiple agents in an apparatus including a processor and memory comprising:
collecting a raw data set about environment surrounding the multiple agents;
processing the raw data set into a first data set containing at least one of state information, observation information, and action information in reinforcement learning;
generating an episodic future data set from the first data set based on some of the state information, observation information, and action information;
generating an episodic future data prediction model using the episodic future data set; and
learning an optimal policy for decision-making for each of the multiple agents through offline reinforcement learning using the generated episodic future data prediction model or the episodic future data set.

13. The method of claim 12, wherein generating the episodic future data prediction model comprises,
inputting data included in the first data set as sample data into the episodic future data prediction model; and
training the episodic future data prediction model by comparing similarity between first episodic future data inferred from the episodic future data prediction model and second episodic future data previously generated for the sample data.

14. The method of claim 12, wherein the episodic future data set is defined as next state information or next observation information predicted for each agent while its own action is not determined.

15. The method of claim 12, wherein the multiple agents are defined as agents for operating an autonomous vehicle,
wherein the state information includes vectors of speeds, positions, and lane numbers of vehicles around each of the multiple agents,
wherein the observation information includes a relative speed vector between observable vehicles of each of the multiple agents, a relative distance vector, a traffic density vector for each visible lane, and a presence vector of a visible lane.
